(19) United States
(12) Patent Application Publication
(10) Pub. No.: US 2022/0276333 A1
(43) Pub. Date: Sep. 1, 2022

(54) RADIO WAVE SOURCE POSITION ESTIMATION SYSTEM

(71) Applicant: NEC Corporation, Minato-ku, Tokyo (JP)

(72) Inventor: Jun SAKAI, Tokyo (JP)

(73) Assignee: NEC Corporation, Minato-ku, Tokyo (JP)

(21) Appl. No.: 17/632,558

(22) PCT Filed: Sep. 9, 2019
(86) PCT No.: PCT/JP2019/035414

§ 371 Date: Feb. 3, 2022

(51) Int. Cl. G01S 5/02

(52) U.S. Cl. CPC G01S 5/0278

(57) ABSTRACT

The present invention includes: a learning data generation unit (53) that acquires an expected value of a measured value of received power; a spatial distribution synthesis unit (54) that calculates an expected value of a measured value of received power when a radio wave is transmitted from any position in a target area; a likelihood calculation unit (55) that calculates a likelihood distribution that a radio wave source exists at each point of the target area; a position estimation unit (56) that estimates transmission power of a transmission source to be estimated, estimates a likelihood distribution at the transmission power, and estimates a position of the transmission source; and a display unit (57) that displays a spatial distribution of a conformity degree in the target area and a position of a maximum likelihood value and a position of a local maximum value of the likelihood calculated (55).

### TECHNICAL FIELD

The present disclosure relates to a technique of estimating a position of a transmission source of a radio wave, and a radio wave source position estimation method using the technique.

### BACKGROUND ART

In recent years, with progress and popularization of radio technology, frequency resources have been tightened, and importance of effectively using frequencies in time, space, and frequency domains has been increasing. For this reason, a method has been applied in which radio supervisory authorities in various countries generally allocate frequencies to radio users, and radio waves are used within a range of permitted frequencies and radio wave intensities. However, an unauthorized radio station that uses radio waves without acquiring a radio station license transmits radio waves with excessive output, or a licensed radio station unintentionally transmits radio waves in another band that is unlicensed, resulting in a problem of causing radio wave interference and communication failure. In response to this problem, in Japan, the Ministry of Internal Affairs and Communications has deployed a radio wave monitoring system (Detect Unlicensed Radio Stations: DEURAS) illustrated in NPL 1 nationwide, and estimates a position of an illegal radio station by measuring intensity and arrival directions of radio waves, thereby attempts to ensure proper use of radio waves. For example, a countermeasure of referring to map information and determining whether a position of an estimated radio wave source is an illegal radio station or a legitimate radio station which has acquired a license, or searching a vicinity of the estimated position in detail by a movable radio wave sensor is conceivable.

As a method of estimating a position of a radio wave source, for example, NPL 2 and PTL 1 propose a method using a received signal strength indicator (RSSI) of radio wave intensity measured by a radio wave sensor. In general, received intensity of a radio wave decreases as a radio wave sensor moves away from a transmission source, i.e., as a propagation distance of the radio wave increases. NPL 2 proposes a method of setting a relational expression of the propagation distance and the received intensity, calculating an expected value of received power when the transmission source exists at each point in a target area for each point, and estimating a position where a measured value of the received power in the radio wave sensor best conforms the above-described expected value, as a position of the transmission source.

However, in urban areas, the received intensity does not become a simple function of the distance because of reflection and shielding of radio waves by buildings and objects, and a difference occurs between an actual measured value and an expected value of the point, and accuracy of position estimation is greatly deteriorated. Therefore, PTL 1 proposes a method of calculating an expected value by setting a position of a shielding object or a breakpoint for each azimuth seen from a radio wave sensor and setting an attenuation parameter of a relational expression of a propagation distance and received intensity for each region. Note that, these methods can be applied even when a measured physical quantity of the radio wave sensor is a time of arrival (ToA), a time differential of arrival (TDoA), or an angle of arrival (AoA).

Further, PTL 2 proposes a method of considering an influence of reflection and shielding due to buildings and objects in an urban environment in more detail. PTL 2 differs from NPL 2 in that a channel impulse response (CIR) is measured instead of the radio wave intensity, accordingly in that a positional fingerprint is used instead of the relational expression of the propagation distance and the received intensity, and in a method of evaluating a conformity degree, but is common with NPL 2 in that an expected value of a measured value when a radio wave is transmitted from any point in a target area is acquired and a position where the measured value best conforms is used as an estimated position of the transmission source. In this prior example, in order to accurately acquire a complicated radio wave propagation state in the urban environment, a radio wave source is mounted on a vehicle, and travels in a target area while transmitting a training signal, and the training signal is received by a radio wave sensor. Then, measured data are subjected to spatial complementation by kriging, and an expected value of the measurement value when the radio wave is transmitted from any point in the target area is acquired.

As described above, in estimating a position of a radio wave source in an environment in which reflection and shielding of a radio wave by a building or an object occur, a method has been proposed in which an expected value of a measured value of a radio wave sensor is set for each point in a target area, and a position which best conforms the measured value of the radio wave sensor is set as a position of the transmission source.

### CITATION LIST

### Patent Literature

PTL 1: Japanese Unexamined Patent Application Publication No. 2017-67529
PTL 2: Japanese Patent No. 6399512

### Non Patent Literature

NPL 1: Ministry of Internal Affairs and Communications, Radio Monitoring System, http://www.tele.soumu.go.jp/j/adm/monitoring/moni/type/deurasys/
NPL 2: Shinsuke Hara: Statistical Estimation Theory in Location, IEICE Fundamentals Review, 4-1, 32/38 (2010)

### SUMMARY OF INVENTION

### Technical Problem

The following analysis is provided by the inventor of the present invention. When an expected value of a measured value of a radio wave sensor is set to be discontinuous according to a building, an object, or a breakpoint in a city as in PTL 1 and PTL 2, points having substantially the same expected values are discontinuously distributed. In the method in PTL 2, the expected values are distributed continuously at first glance, but there is also a point having substantially the same expected value at a distant place. Accordingly, positions that conform the measured value of the radio wave sensor to the same extent simultaneously occur at distant places, and then, a position that conforms the most among the positions is output as a final estimated position. Meanwhile, in actual measurement, a transmission output and a propagation state of a radio wave source frequently fluctuate, and therefore a measured value of a radio wave sensor also fluctuates. Therefore, there is a problem that a point that best conforms to the measured value among the plurality of points that conform to the measured value to substantially the same extent may shift, and the estimated position abruptly changes discontinuously and largely because these points are largely distanced from each other. In this case, since it is not possible to distinguish between a case where the transmission source actually moves largely at high speed and a case where an estimation error is large, it is difficult to analyze the transmission source whose position has been estimated. For example, it is difficult to determine whether the transmission source to be estimated is a transmission source mounted on a mobile body or a transmission source that is not moving, and it is also difficult to determine whether the transmission source is a licensed radio station or an illegal radio station. Note that, even when time-series filter processing such as moving average or Kalman filter is applied in time-series to a result of position estimation, the time-series filter is not effective because a position in a middle of a plurality of candidate points is output as an estimation result and an error becomes large.

In view of the above-described problems, an object of the present disclosure is to provide a method of accurately acquiring an estimated position of a radio wave source even in a case where a fluctuation in a position of the radio wave source is large in an urban environment in which reflection/shielding of a radio wave by a building or an object occurs.

### Solution to Problem

In order to solve the above-described problems, a radio wave source position estimation device according to the present disclosure includes: a learning data generation unit that acquires, based on a measured radio wave feature value of a radio wave transmitted from a referential transmission source at a known position, an expected value of the measured radio wave feature value when a radio wave is transmitted from the known position; a spatial distribution synthesis unit that calculates, by synthesizing the expected value at the known position, an expected value of a measured value when a radio wave is transmitted from any position in a target area; a likelihood calculation unit that calculates, based on a conformity degree between the expected value and received power measured by a radio wave sensor, a likelihood distribution that a radio wave source exists at each point in the target area; a position estimation unit that calculates, based on the likelihood distribution calculated by the likelihood calculation unit, a position where a likelihood becomes a local maximum value or a maximum value; and a display unit that displays a spatial distribution of the likelihood in the target area and an estimated position of a transmission source.

Further, a local maximum value to be displayed is limited to a local maximum value of which a likelihood difference from a maximum value is within a range of a set threshold value. Further, among those local maximum values, a local maximum value of which a likelihood has become the maximum value in a specified time period is displayed as a quasi-transmission source position, and the other local maximum values are displayed as referential transmission source positions.

In addition, a place where the likelihood reaches the maximum value in the specified time period is displayed.

In addition, a radio wave source position estimation method according to the present disclosure includes calculating a likelihood at each point in a target area at a plurality of specified times, performing statistical processing on the likelihoods of the plurality of times at each point, and displaying a spatial distribution of the likelihoods after the statistical processing for the point.

### Advantageous Effects of Invention

According to the present disclosure, in an urban environment in which reflection/shielding of a radio wave by a building or an object occurs, even when an estimated position of a radio wave source largely and discontinuously changes, a position of the radio wave source can be stably acquired.

### BRIEF DESCRIPTION OF THE DRAWINGS

FIG. 1 is a configuration diagram of a radio wave source position estimation method according to the present example embodiment.

FIG. 2 is a configuration diagram of a radio wave source position estimation system according to the present example embodiment.

FIG. 3 is a diagram illustrating a schematic configuration of a position estimation device according to the present example embodiment.

FIG. 4 is a diagram illustrating a processing configuration of the position estimation device according to the present example embodiment.

FIG. 5 is a diagram for explaining an operation of the system at a time of learning according to the present example embodiment.

FIG. 6 is a diagram for explaining a method of complementing a value of a place where a radio wave is not transmitted from a referential transmission source according to the present example embodiment.

FIG. 7 is an expected value distribution of all grids of a target region acquired by performing spatial complementation by ordinary kriging, based on learning data according to the present example embodiment.

FIG. 8 is a diagram illustrating a processing configuration of a likelihood calculation unit according to the present example embodiment.

FIG. 9 is a diagram illustrating an example of a likelihood distribution according to the present embodiment.

FIG. 10 is a diagram illustrating a processing configuration of a position estimation unit according to the present example embodiment.

FIG. 11 is a diagram illustrating a likelihood distribution according to the present example embodiment with color shades, and also illustrating an estimated source position, a quasi-transmission source position, and a referential source position with different markers.

FIG. 12 is a diagram illustrating processing in a learning phase according to the present example embodiment.

FIG. 13 is a diagram illustrating processing in a position estimation phase according to the present example embodiment.

FIG. 14 is a diagram illustrating one example of an output likelihood distribution according to the present example embodiment.

FIG. 15 is a diagram illustrating a disposition of sensors according to the present example embodiment.

FIG. 16 is a diagram illustrating a spatial distribution of expected values synthesized for each of the sensors according to the present example embodiment.

FIG. 17 is a diagram illustrating one example of a likelihood distribution according to the present example embodiment.

FIG. 18 is a diagram illustrating one example of a coupled likelihood distribution according to the present example embodiment.

FIG. 19 is a diagram illustrating one example of an estimated likelihood distribution according to the present example embodiment.

FIG. 20 is a diagram plotting a relationship between a measured value of received power and a distance between a referential transmission source of the received power and a sensor according to the present example embodiment.

FIG. 21 is a diagram illustrating one example of an expected value distribution according to the present example embodiment.

FIG. 22 is a diagram illustrating one example of a likelihood distribution of each radio wave sensor according to the present example embodiment.

FIG. 23 is a diagram illustrating one example of a coupled likelihood distribution according to the present example embodiment.

### DESCRIPTION OF EMBODIMENTS

In the following, an example embodiment of the present disclosure will be described in detail with reference to the drawings.

### First Example Embodiment

First, a configuration of the radio wave source position estimation system according to a first example embodiment will be described.

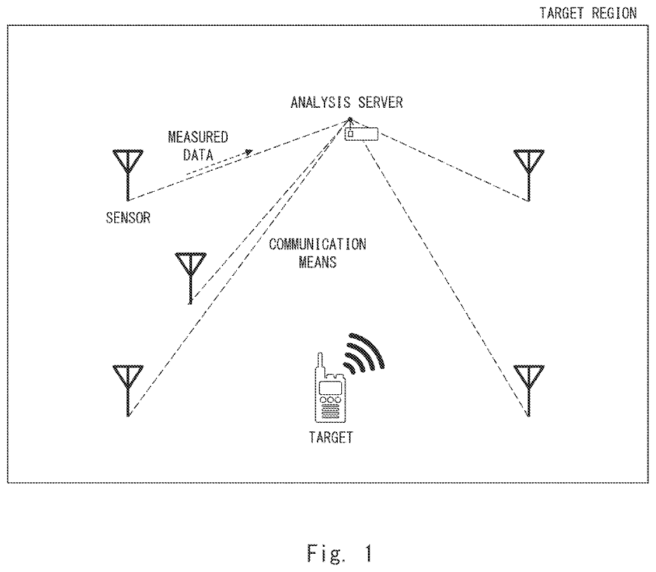

FIG. 1 is a diagram for explaining an operation of a radio wave source position estimation system according to the first example embodiment. Radio wave sensors are disposed in a target region of position estimation and measures a radio wave feature value. As the radio wave feature value, intensity of a received radio wave RSSI, channel impulse response (CIR), ToA, TDoA, AoA, or the like may be used. In the present example embodiment, description is made on an assumption that the radio wave feature value is a RSSI. In this case, the radio wave having a frequency to be detected is received, and received intensity thereof is recorded. Each radio wave sensor is time-synchronized, and the received intensity is transferred to an analysis server together with time information. Data transmission may be performed via a wireless LAN such as Wi-Fi or a wireless NW such as a mobile network such as LTE, or via a wired NW such as Ethernet. In a radio wave sensing processing server, when the received intensity transmitted from the radio wave sensor exceeds a predetermined threshold value, a position of a radio wave source is estimated by using a method described in the following.

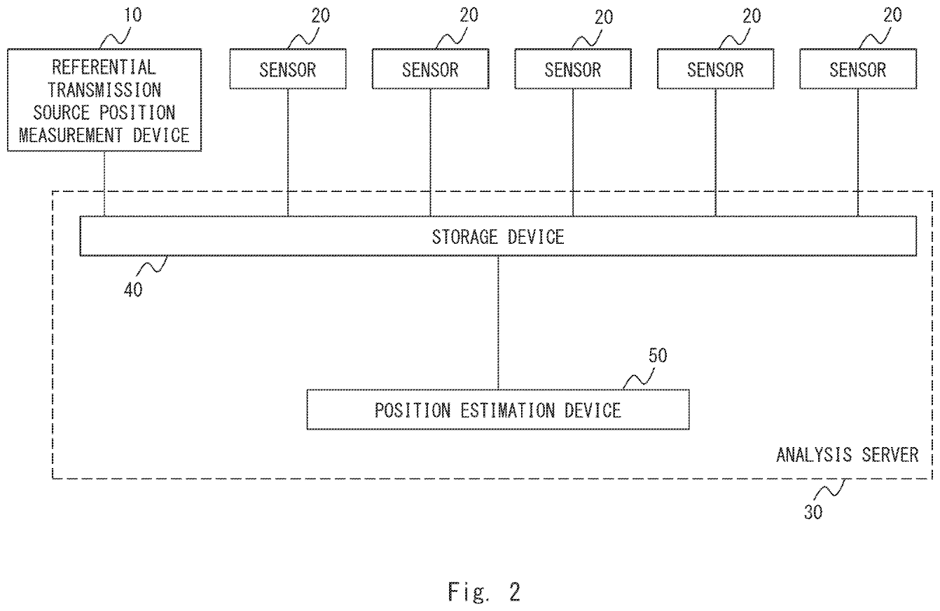

FIG. 2 illustrates the configuration of the radio wave source position estimation system according to the first example embodiment. A storage device 40 and a position estimation device 50 are built in an analysis server 30. A sensor 20 and the storage device 40 are wired or wirelessly connected, and a radio wave feature amount measured by the sensor 20 is stored. Further, position information of a referential source measured by a referential transmission source position measurement device 10 at a time of learning is stored in the storage device 40. The referential transmission source position measurement device 10 is capable of using a GNSS receiver such as a GPS to receive a signal from a positioning satellite, and estimates its own position and stores positioning information in the own device. The measured positioning information may be sequentially transferred to the storage device 40, or may be collectively transferred to the storage device 40 after all learning is completed. The transfer of the positioning information may be performed via a wired connection such as USB or a wireless LAN such as Wi-Fi. Then, the position estimation device 50 fetches the position of the referential source stored in the storage device 40 and the measured value measured by the sensor 20, and performs position estimation.

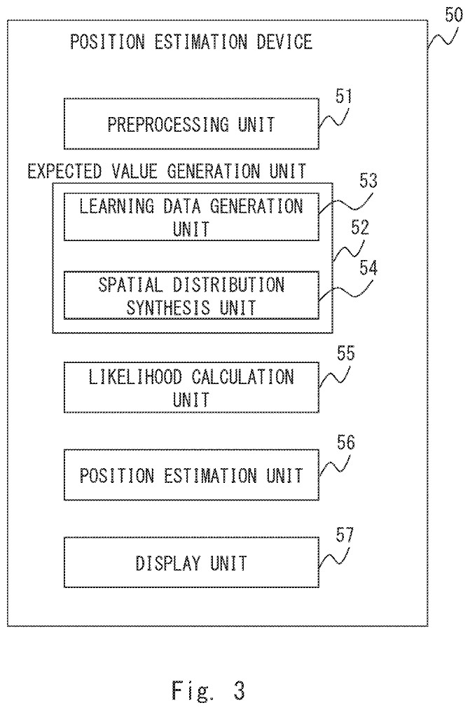

FIG. 3 is a diagram illustrating a schematic configuration of the position estimation device 50. The position estimation device 50 includes a preprocessing unit 51, an expected value generation unit 52 including a learning data generation unit 53 and a spatial distribution synthesis unit 54, a likelihood calculation unit 55, a position estimation unit 56, and a display unit 57.

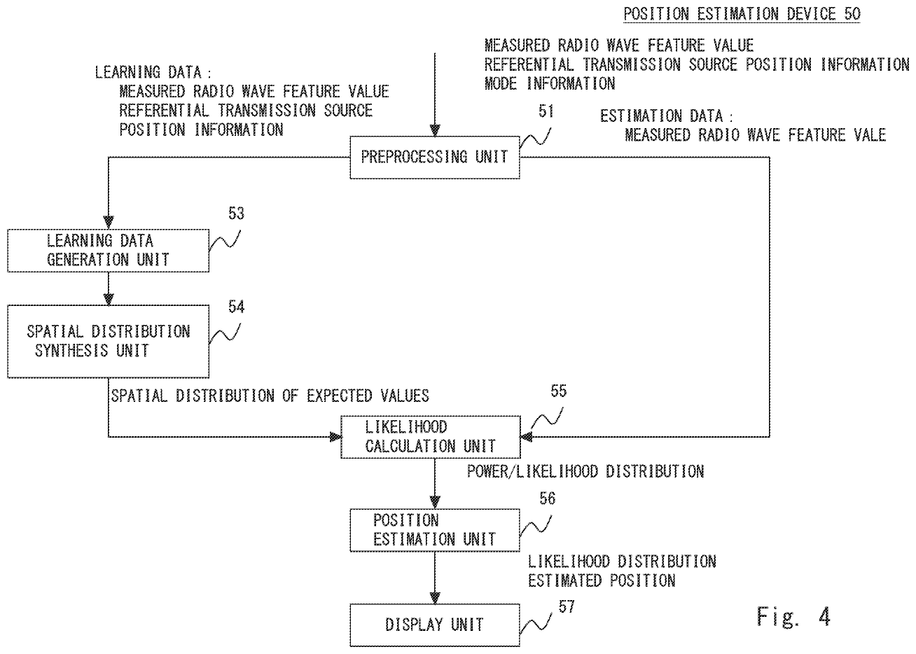

FIG. 4 is a diagram illustrating a processing configuration of the position estimation device 50.

First, the preprocessing unit 51 fetches, from the storage device 40, mode information of a radio wave sensor, a measured radio wave feature value, and referential transmission source position information. The mode information is information specifying whether these data are for learning or for position estimation. Further, when the measured value is less than a predetermined threshold value, it may be considered that no radio wave is transmitted and measured data at that time may be removed, and preprocessing such as interconversion of the measured value between a linear unit and a logarithmic unit, normalization, standardization, or the like, moving average of the measured data at adjacent times in time series, and data cleansing processing such as noise filtering, abnormal value removal, or the like may be included. Then, the input data are classified into learning data or estimation data, according to the mode information.

The learning data generation unit 53 compares the measured radio wave feature value, which is time-series data, with the referential transmission source position information, which is time-series data, and couples the data of the same time. As a result, the measured radio wave feature value at a time of learning and the position of the referential transmission source at that time are linked. Further, preprocessing such as aggregating, by statistical processing such as averaging, a plurality of pieces of the measured data of which source positions are within a predetermined distance.

The spatial distribution synthesis unit 54 calculates, by synthesizing from learning data, an expected value of a measured radio wave feature value when a radio wave is transmitted from a referential transmission source at a point in an analysis target region where no learning data exists. As a result, for each point acquired by dividing the analysis target region by a predetermined interval, an expected measured value of each sensor when the referential transmission source transmits a radio wave from the point is acquired. This is referred to as a spatial distribution of expected values.

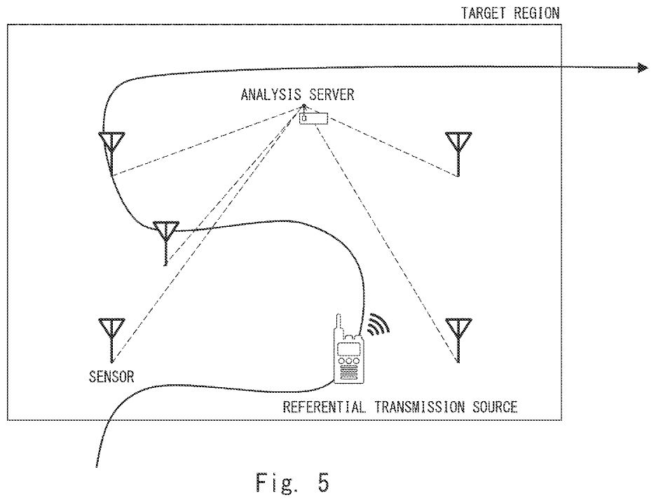

A method of calculating the spatial distribution of expected values will be described with reference to FIGS. 5 to 7. FIG. 5 is a diagram for explaining an operation of the system at the time of learning. The radio wave sensor is arranged in a similar way as in FIG. 1, and a preparation for measuring a radio wave feature value is made. Then, the referential transmission source is moved within the target region while transmitting a radio wave. At this time, a GNSS receiver is held together with the referential transmission source, and a position of the referential transmission source is measured. The radio wave transmitted from the referential transmission source is measured by all the sensors, transmitted to the analysis server, and stored. Those measured data are learning data and are preferably collected for many positions. Therefore, in actual operation, the referential transmission source and the GNSS receiver are mounted on a vehicle, and a radio wave is transmitted while the vehicle travels on a road in a target area. However, since the vehicle can only travel on a roadway and cannot travel on a walkway or a place with a building, the referential transmission source cannot transmit from all points in the target area. Even if the target area is a place without any obstacles, such as a plain field, it is not realistic to transmit a referential signal from all points. Thus, a point where no radio wave is transmitted from the referential transmission source occurs, and therefore it is necessary to complement a value of the point.

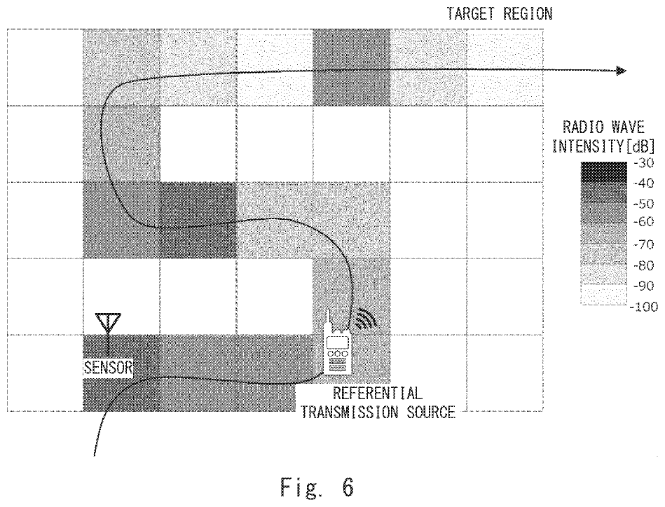

FIG. 6 is a diagram for explaining a method of complementing a value of a place where no radio wave is transmitted from the referential transmission source. First, the target region is divided into small grids. Thereafter, the following processing is performed for each sensor. Normally, since referential signals are transmitted from a plurality of points in each grid, a representative statistic of all measured values when the referential transmission source transmits a radio wave from each of the divided grids is calculated as an expected value of the grid. As the representative statistic, a mean value, a maximum value, a median value, a 75th percentile value, or the like may be used. In FIG. 6, the values are displayed with color shades.

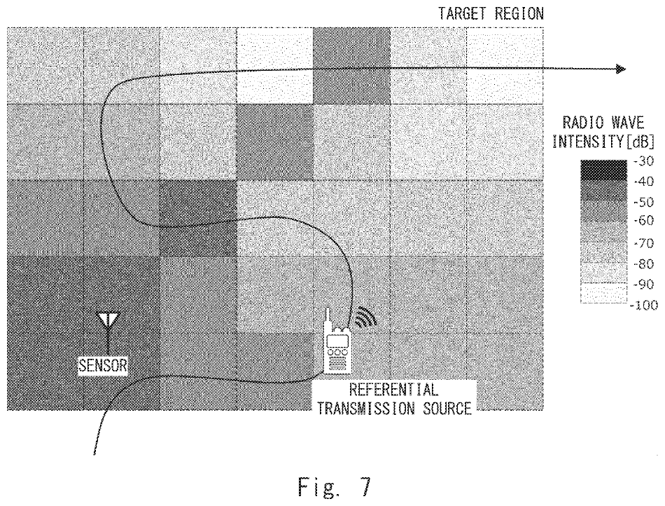

Next, as illustrated in FIG. 7, an expected value of a grid where the referential transmission source has not passed and no value has been acquired is spatially complemented by using an expected value of a surrounding grid of which value has been acquired. As a method of spatial complementation, there are methods such as linear complementation, stereoscopic complementation, spline complementation, and kriging, but kriging, which is a spatial complementation technique widely used in geographic information systems, is considered to be most suitable. A type of kriging may be ordinary kriging, which complements the measured value as it is, or unbiased kriging (or trended kriging) using a relational expression between a propagation distance and received intensity expressed by Expression 1 as a trend. A case of unbiased kriging corresponds to performing normal kriging on a difference between the expected value of the grid of which learning data exists and a result of Expression 1, and outputting, to a result of complementation, a sum of powers of Expression 1 as an expected value. Herein, (x, y) represents position coordinates of a radio wave source, (xₙ, yₙ) represents position coordinates of a radio wave sensor n, dₙ (x, y) represents a distance between the radio wave sensor n and the radio wave source, and (α, β) represents propagation constants. FIG. 7 is an expected value distribution of all the grids in the target region acquired by performing spatial complementation using ordinary kriging, based on the learning data of FIG. 6. This is the expected value distribution for one sensor, and this processing is performed for all the sensors.

\tilde{P}ₙ(x,y)=α·dₙ(x,y)^{-β}dₙ(x,y)=\sqrt{(x−xₙ)²+(y−yₙ)²} [Expression 1]

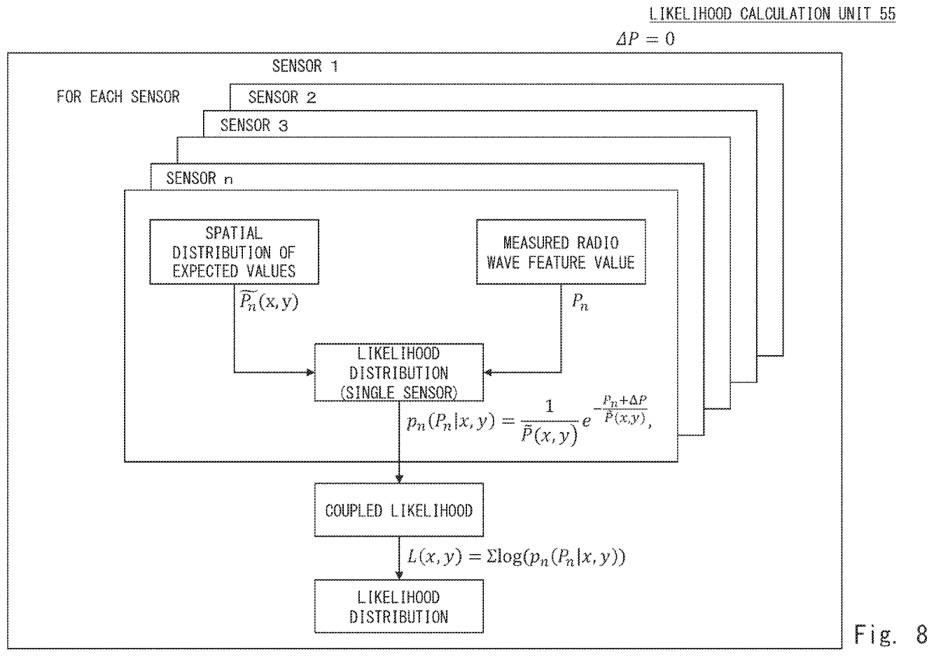

Return to FIG. 4. The likelihood calculation unit 55 compares the measured radio wave feature value for position estimation and the spatial distribution of the expected values, and calculates a likelihood that the radio wave source exists at a point for all the grids in the analysis region. The likelihood is one kind of an indicator of a conformity degree between the expected value and the measured value, and in a case of generalization, the likelihood is included in the conformity degree. As one example of the likelihood, in a case of Rayleigh fading, which is multipath fading in which only a large number of scattered waves are received without a prominent direct wave, a probability density distribution of a physical quantity acquired by squaring received intensity of the scattered wave becomes an exponential function, and a likelihood thereof is acquired by using the exponential function. FIG. 8 is a diagram illustrating a processing configuration of the likelihood calculation unit 55. When a radio wave feature value measured by the sensor n is Pₙ and a spatial distribution of expected values of all grids of the sensor n is

[symbol]

(x,y),

a likelihood that the sensor n receives a signal having received power of Pₙ when the transmission source is present at any position (x,y) in the target region

p(Pₙ|x,y)

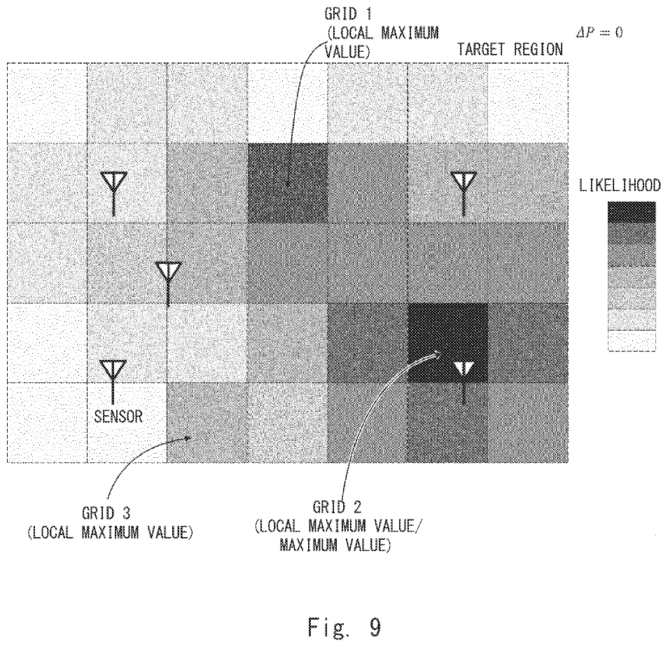

is given by Expression 2. When this is calculated for all the grids in the target region, the likelihood distribution of a transmission source position of the radio wave sensor n is acquired. A coupled likelihood distribution considering all the radio wave sensors is acquired by multiplying the likelihood distribution of each of the radio wave sensors, but when treated as a true number, a difference between a minimum value and a maximum value is large, and when a coupled likelihood value is expressed with color shades on a map, only the maximum value is emphasized and it becomes difficult to acquire a position of another local maximum value. Therefore, a likelihood of each of the sensors is first converted to a logarithm as in Expression 3, and a coupled log likelihood L, which is a sum of the logarithmic likelihoods, is calculated as the likelihood considering all the sensors. When the log likelihood L is calculated for all the grids in the target region, a coupled log likelihood distribution L (x, y) considering all the sensors is acquired. Hereinafter, the coupled log likelihood distribution is referred to as a likelihood distribution. An example of the likelihood distribution is illustrated in FIG. 9.

$$p ( {P}_{n} \vert x , y ) = \frac{1}{\tilde{P} ( x , y )} {e}^{- \frac{{P}_{n}}{\tilde{P} ( x , y )}} \qquad [ Expression 2 ]$$

$$L ( x , y ) = {\sum }_{k = 1}^{n} log ( p ( {P}_{n} \vert x , y ) ) \qquad [ Expression 3 ]$$

It should be noted that the likelihood of Expression 2 and the likelihood distribution of Expression 3 and FIG. 9 are likelihoods in a case where the power of the transmission source is equal to the power of the referential transmission source used in the learning phase. Since transmission power of an unknown transmission source being a target of position estimation in practice is different from power of a referential transmission source in most cases, in order to accurately estimate the position, it is necessary to also estimate the transmission power of the transmission source being the target of position estimation. Herein, a difference P_{TX}−P_{TX0} between transmission power P_{TX0} of the referential transmission source and transmission power P_{TX} of the transmission source to be estimated is ΔP. Then, the likelihood that the sensor n receives the power of Pₙ when the transmission source whose transmission power difference between the referential transmission source is ΔP exists at any position (x, y) in the target region

p(Pₙ|x,y,ΔP)

is given by Expression 4 and the coupled log likelihood distribution L (x, y, ΔP) considering all the sensors is given by Expression 5.

$$p ( {P}_{n} \vert x , y , Δ P ) = \frac{1}{\tilde{P} ( x , y )} {e}^{- \frac{{P}_{n} + Δ P}{\tilde{P} ( x , y )}} \qquad [ Expression 4 ]$$

$$L ( x , y , Δ P ) = {\sum }_{k = 1}^{n} log ( p ( {P}_{n} \vert x , y , Δ P ) ) \qquad [ Expression 5 ]$$

The likelihood calculation unit 55 sweeps ΔP in a predetermined range and interval, calculates a likelihood distribution at each ΔP, and collectively outputs the plurality of likelihood distributions to the position estimation unit 56, as a power/likelihood distribution. Since the likelihood distribution illustrated in FIG. 9 is likelihood distribution for a single ΔP, there is likelihood distribution for each ΔP as many as the number of swept ΔP, and the likelihood distributions are collectively output as the power/likelihood distribution.

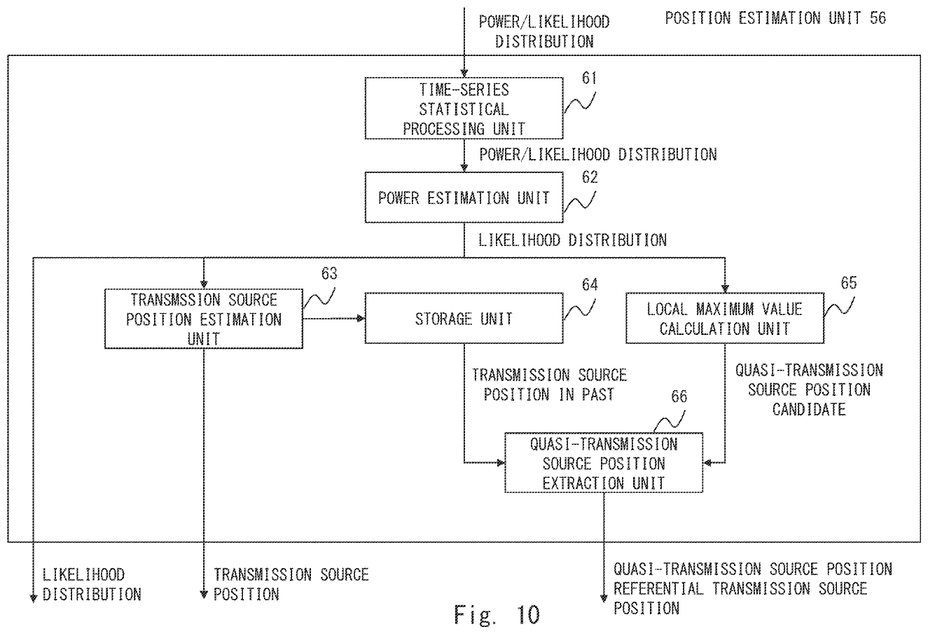

Returning to FIG. 4, the position estimation unit 56 estimates the position of the transmission source, based on the calculated power/likelihood distribution. FIG. 10 is a diagram illustrating a processing configuration of the position estimation unit 56. The position estimation unit 56 includes a time-series statistical processing unit 61, a power estimation unit 62, a transmission source position estimation unit 63, a local maximum value calculation unit 65, a storage unit 64, and a quasi-transmission source position extraction unit 66.

The time-series statistical processing unit 61 performs statistical processing on time-series data of a likelihood distribution including times before and after a position estimation target time. Specifically, filter processing such as averaging, weighted averaging, Kalman filtering, and the like is performed over a set time width on a likelihood value of each grid, and a result thereof is output as a likelihood at the time. These time-series filter processing are performed on each of the likelihood distributions at each of the power difference values ΔP. Note that, this processing may not be necessarily performed, and the value of the likelihood of the estimation target time may be output as it is.

The power estimation unit 62 estimates transmission power of the transmission source being the estimation target, and outputs a spatial distribution of a likelihood at that transmission power. First, a maximum value among the likelihoods in all powers/grids is searched from among the power/likelihood distribution output from the time-series statistical processing unit 61. Then, ΔP that gives the maximum value is acquired, and a likelihood distribution of all grids at that ΔP is output.

The transmission source position estimation unit 63 extracts a grid at which a likelihood becomes the maximum among all grids in the likelihood distribution output by the power estimation unit 62, and outputs a position of the grid as a transmission source position. At the same time, the position and a measurement time of a measured value that has been used for calculating the likelihood are stored in the storage unit 64.

The local maximum value calculation unit 65 compares likelihoods of all grids with a likelihood of an adjacent grid in the likelihood distribution output from the time-series statistical processing unit 61, and extracts a grid having a likelihood larger than a likelihood of an adjacent grid, and the likelihood. Then, a maximum value is determined from among these local maximum values, and among local maximum values other than the maximum value, a local maximum value whose difference from the maximum value is within a predetermined threshold value is set as a quasi-transmission source position candidate, and a position thereof is output. In the example in FIG. 9, since a grid 1, a grid 2, and a grid 3 have local maximum values and since the grid 2 has the maximum value, the grid 1 and the grid 3 are output as positions of the local maximum values. Then, a difference between a likelihood of the local maximum values of the grids 1 and 3 and a likelihood of the maximum value of the grid 2 is calculated, and when the difference is within a predetermined threshold value, the difference is output as a quasi-transmission source position candidate. Note that, when there is no local maximum value other than the maximum value or when there is no local maximum value whose difference from the maximum value is within the threshold value, nothing is output.

First, the quasi-transmission source position extraction unit 66 fetches, from the storage unit 64, information on the transmission source position for a period in which a set time is gone back from a position estimation target time. When the quasi-transmission source position candidates are output from the local maximum value calculation unit 65, the quasi-transmission source position candidate of the same grid as the transmission source position in the past among the quasi-transmission source position candidates is output from among the quasi-transmission source position candidates, as the quasi-transmission source position. At this time, the position may not be exactly the same as the transmission source position in the past, and a quasi-transmission source position candidate that is within a predetermined distance from the transmission source position in the past may be included in the quasi-transmission source position. The other quasi-transmission source position candidates are output as referential source positions. Accuracy of these transmission source positions to be output is the highest for the source position, followed by the quasi-transmission source position, and the referential source position is a transmission source position having a lowest accuracy. In the example in FIG. 9, it is assumed that the grid 1 is a position where the likelihood becomes the maximum in the past within the set time period, and is estimated as the transmission source position, and is determined as the quasi-transmission source position. It is assumed that the grid 2 is determined as the transmission source position because the grid 2 has the maximum likelihood, and that the grid 3 is determined as the referential transmission source position because the grid 3 has not reached the maximum likelihood in the past within the set time period.

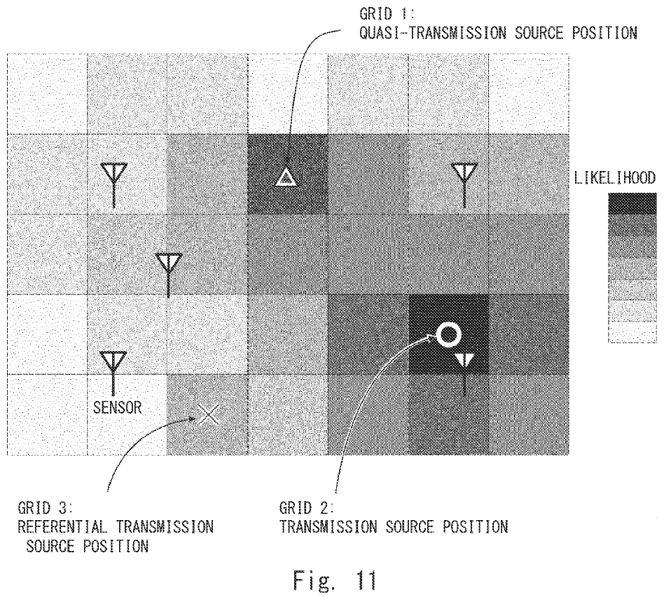

Returning to FIG. 4, the display unit 57 displays an input likelihood distribution and an estimated position on a display device such as a display or a projector. The estimated position referred to herein includes the source position, the quasi-transmission source position, and the referential source position illustrated in FIG. 10. FIG. 11 is one example thereof, in which the likelihood distribution illustrated in FIG. 9 is displayed with color shades, and the estimated transmission source position, the quasi-transmission source position, and the referential transmission source position are displayed with different markers. Although only the estimated transmission source position at the target time is displayed here, an estimated position in the past within a set period may also be displayed at the same time. In such a case, processing may be performed in such a way that a color of a marker is made lighter for an estimated position that is further back from the target time to the past.

Next, processing in the radio wave source position estimation system according to the first example embodiment will be described. First, in description of an outline of the process, the system is divided into a learning phase and an estimation phase. In the learning phase, first, a referential transmission source moves within a target region while transmitting a radio wave and being measured for position, and a signal thereof is received by a sensor. On the bases of the measured value and positioning information, an expected value of a measured value of each sensor when a radio wave is transmitted from each point is synthesized for all the points in the target region, and a spatial distribution of the expected values is output. In the estimation phase, a position of a radio wave source to be estimated is estimated, based on the spatial distribution of the expected values and the measured value of the sensor.

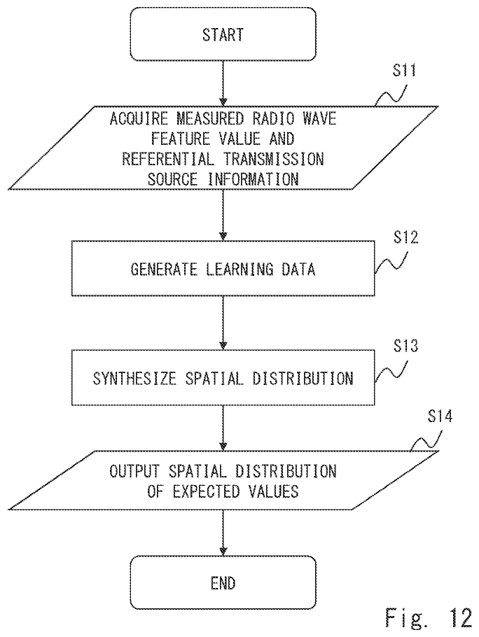

FIG. 12 illustrates processing in the learning phase. First, a measured value of a radio wave feature value of the referential transmission source measured by the radio wave sensor and position information of the referential transmission source are fetched (S11). Next, learning data is generated by coupling the measured value and the position information of the referential transmission source that have been measured at the same time (S12). Next, in synthesis of a spatial distribution, an analysis region is first divided into grids, and a representative statistic is calculated for a grid through which the referential source has passed. Next, a spatial distribution is synthesized by using a spatial complementation technique such as kriging for a grid through which the referential source has not passed (S13). As a result, an expected value of a measured value of the radio wave sensor when the referential transmission source transmits a signal from each grid is acquired for all the grids in the target region. By performing this processing for each radio wave sensor, a spatial distribution of the expected values is calculated and output (S14).

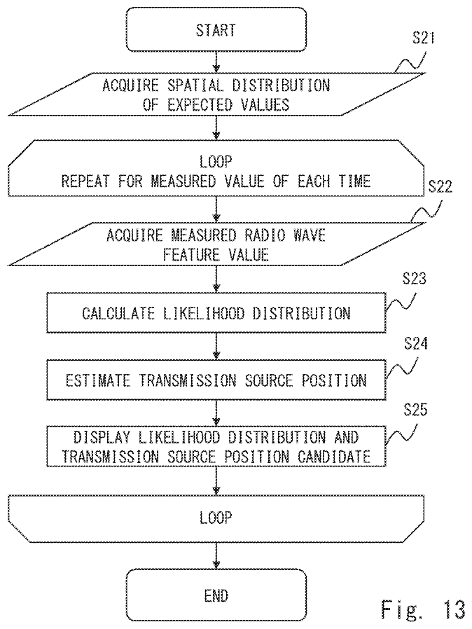

Next, the processing of the position estimation phase will be described by using FIG. 13. First, the spatial distribution of the expected values of the sensors generated in the learning phase is acquired (S21). Next, the measured radio wave feature value measured by the radio wave sensor is acquired (S22). In a case where the measurement is performed in real time, the position estimation may be performed by sequentially fetching the measured value of the sensor, otherwise, the position estimation may be performed by sequentially fetching the measured values in the past in chronological order. Then, the following position estimation processing is performed for each time with respect to the measured values of the plurality of sensors measured at the same time. First, likelihoods are calculated for all grids of the analysis target region, from the spatial distribution of the expected values, and the measured value of the radio wave sensor (S23). Then, a transmission source position is estimated, based on the likelihood distribution (S24). The transmission source position includes a transmission source position at which the likelihood at a target time becomes a maximum value, a quasi-transmission source position, which is a position among positions at which the likelihood becomes a local maximum value and is a position at which the likelihood is within a range of a set threshold value from the maximum value and at which the likelihood has become the maximum value in the past within a set time period, and a referential source position at which the likelihood becomes a local maximum value that is a likelihood within the range of the set threshold value from a maximum value of another likelihood. The calculated likelihood distribution and the estimated transmission source position are displayed on the display device. At this time, not only the estimated position at the estimation target time but also a position estimated in the past may be displayed at the same time.

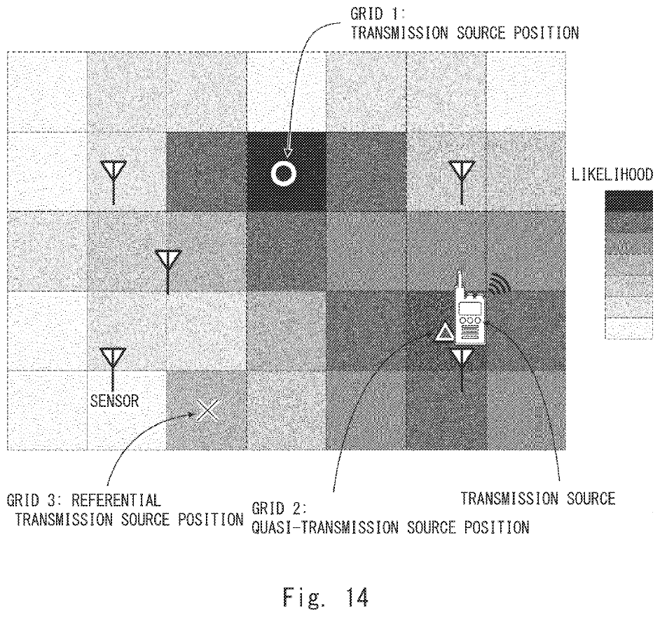

In a general method, a position at which a likelihood becomes a maximum value is output as an estimated value, but in the present disclosure, a position of another local maximum value is calculated at the same time, and information of a position at which the likelihood becomes maximum in the past is referred to, and thereby a local maximum value at which the likelihood becomes the maximum within the specified period is output as the quasi-transmission source position. Further, a position of another local maximum value is output as a referential transmission source position. A case in which this is effective will be described. It is assumed that a transmission source to be estimated transmits a radio wave from a grid 2 in FIG. 11 at a certain time t₁, and a likelihood distribution estimated by measuring the radio wave is the likelihood distribution illustrated in FIG. 11. At this time, since the likelihood of the grid 2 is maximum in the entire estimation region, the position estimation system estimates the grid 2 as the transmission source position, and the estimation is correct. At a time t2 at which the position estimation is performed next, the transmission source to be estimated remains at the same position and the transmission of the radio wave is continued, but it is assumed that the measured value of the radio wave sensor fluctuates slightly because a propagation environment has changed due to a movement of reflective and shielding objects such as a vehicle and people around the transmission source and the sensor, and the likelihood distribution illustrated in FIG. 11 fluctuates slightly and the likelihood distribution illustrated in FIG. 14 is output. At this time, the likelihood distribution is almost the same as in FIG. 11 as a whole, but a likelihood of a grid 1 becomes larger than a likelihood of the grid 2 and becomes the maximum, and the grid 1 is estimated to be the transmission source position. In the general method, only a position at which a likelihood and a conformity degree are maximized is output and therefore it is estimated that the transmission source position has largely moved from the grid 2 to the grid 1. In this case, it is difficult to determine whether the transmission source to be estimated has actually moved or an error is large. Further, when there is a known radio station that has acquired a license in the grid 2, it is determined that there is another radio station in the grid 1 in a case of the time t2 when the likelihood distribution in FIG. 14 is output. Such a case is a phenomenon that occurs more frequently, among techniques described in Citation List, in a case described in PTL 1 and PTL 2 where the expected value of the measured value of the radio wave sensor is set discontinuously than in a case described in NPL 2 where a continuous expected value distribution is used. On the other hand, according to the method of the present disclosure, it can be analyzed that there is a possibility that a transmission source is also present in the grid 2. Since the transmission source position and the quasi-transmission source position are largely separated from each other, it is possible to analyze that a possibility that this is a case with a large position estimation error is higher than a possibility that this is a case where the transmission source has moved at high speed, and it is possible to analyze a radio station on an assumption that the transmission source exists in each of the grid 1 and the grid 2.

### Example 1

An example of the radio wave source position estimation system according to the first example embodiment will be described by using a practical example.

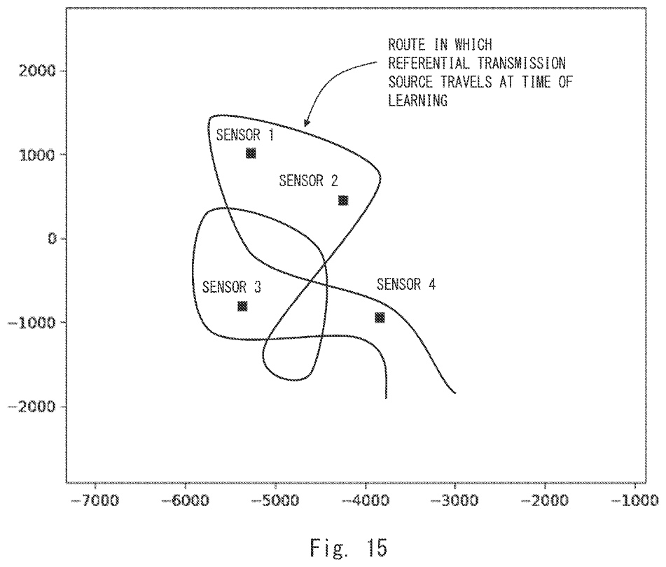

First, sensors 1 to 4 are disposed as illustrated in FIG. 15. (x, y) coordinates of the sensors are in a unit of m, and are sensor 1 (−5270, 950), sensor 2 (−4000, 450), sensor 3 (−5400, −800), and sensor 4 (−3800, −900). Each of the sensors measures power of a radio wave received by an antenna, and transfers a measured value to the server via LTE.

Next, as the learning phase, a referential transmission source is mounted on a vehicle, transmission power is set to 30 dB and transmission is started, the vehicle travels on a route illustrated in FIG. 15, and position information at that time is measured by GPS. Then, the received power of the radio wave at that time is measured by all the sensors. Next, the measured value of the sensor and the position information of the referential transmission source that are measured at the same time are coupled, and thereby learning data are generated.

Next, a spatial distribution is synthesized. First, a target region and grids are set. minimum values and maximum values of x and y coordinates in all the sensors are calculated, and a minimum coordinate point and a maximum coordinate point in the target region are specified. In the present example, the minimum value is (−5400, −900) and the maximum value is (−3800, 950). Then, 2000 m is taken as a margin outside those points and set as the target region. In the present example, the minimum coordinate point of the target region is (−7400, −2900), and the maximum coordinate point is (−800, 2950). Then, the target region is divided by grids having a length of 20 m.

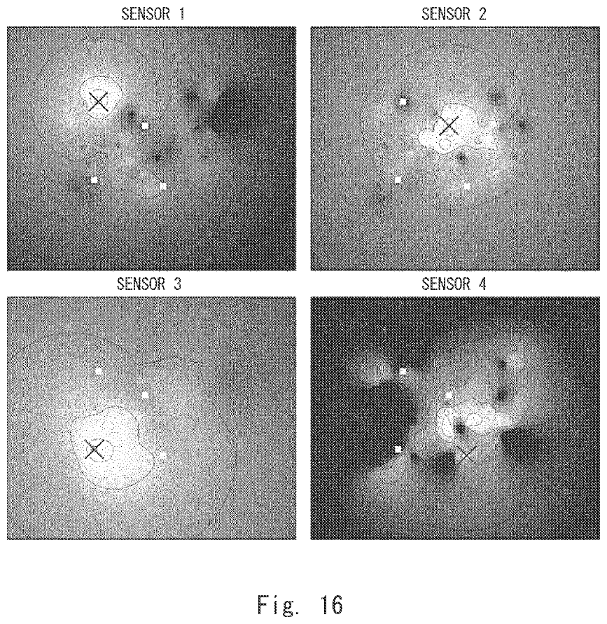

Next, for each of the sensors, for each of all grids having the learning data, an average value of the data in the grid is calculated, and a representative statistic of the grid is calculated. The representative statistic is an expected value of the measured value when the sensor measures a signal transmitted by the referential transmission source from the grid. Then, by using the expected value, an expected value of a grid for which the learning data does not exist is spatially complemented by ordinary kriging. A spatial distribution of the expected values synthesized for each sensor in this way is illustrated in FIG. 16. A magnitude of the expected value is displayed with color shades, a bright color indicates that received intensity of a radio wave transmitted from the point is large, and a dark color indicates that received intensity of a radio wave transmitted from the point is small. Herein, the expected value of the sensor 3 is distributed isotropically around the sensor 3. This is a phenomenon that is often observed when the target region is seen from the sensor 3 with good visibility, or when shielding objects are distributed isotropically. On the other hand, a distribution of the sensor 4 is anisotropic, the intensity is weak in a region close to the sensor 4, and the intensity is strongest in a region slightly apart from the sensor 4. This is a phenomenon often observed when there is a radio wave shielding object only in a specific direction from a sensor, or when a sensor is located on a rooftop of a building or the like and the directivity of an antenna is weak in a direction toward a base of the building. In this way, the spatial distribution of the expected values is calculated, and the learning phase ends.

Next, the position estimation phase is started. First, received intensity of a radio wave from a position estimation target is measured by the all the radio wave sensors. At a certain time t₁, the received intensities of the sensors 1 to 4 is p₁=−89.9 dB, p₂=−77.0 dB, p₃=−85.4 dB, and p₄=−82.9 dB.

A power/likelihood distribution is calculated by using the measured value. ΔP is set in a range of −20 to 20 in 5 dB increments, and likelihoods of all grids at each ΔP

p(Pₙ|x,y,ΔP)

is calculated for each sensor by using Expression 4. Next, a coupled likelihood distribution L (x, y, ΔP) in which the likelihoods of all the sensors are coupled is calculated by using Expression 5. The coupled likelihood distribution L is the power/likelihood distribution.

Next, the position estimation unit 56 estimates transmission power and a likelihood distribution. First, when ΔP at which the likelihood becomes maximum among L (x, y, ΔP) is searched, the maximum likelihood is acquired when ΔP=5. A likelihood distribution of each sensor when ΔP=5

p(Pₙ|x,y,ΔP=5)

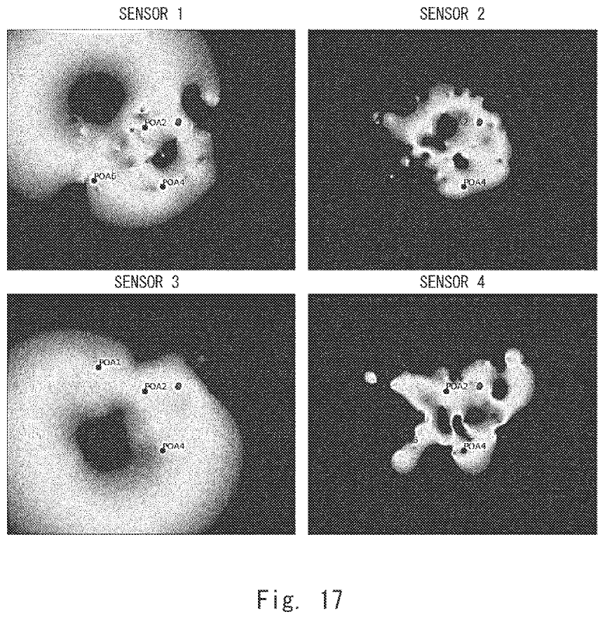

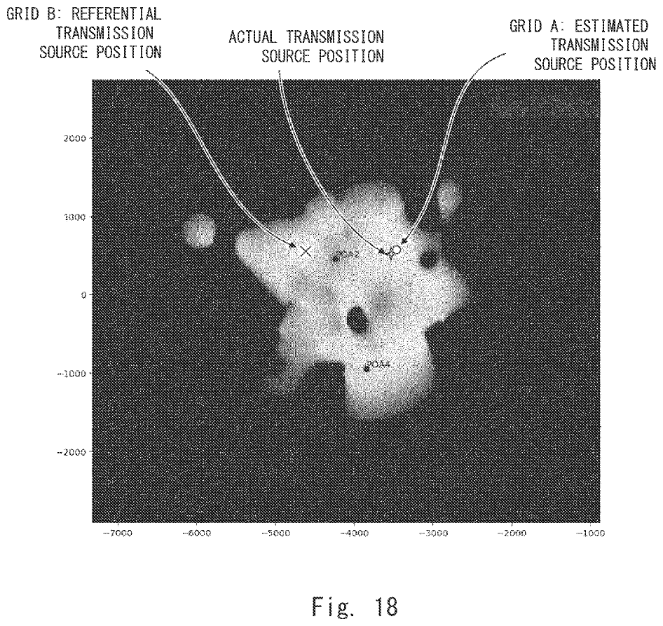

is illustrated in FIG. 17 and the coupled likelihood distribution L (x, y, ΔP=5) is illustrated in FIG. 18. In this likelihood distribution, a grid A having the maximum likelihood is estimated as a transmission source position at the time t₁. Next, local maximum values of the likelihood in this likelihood distribution are calculated, and when a local maximum value that is a coupled log likelihood value acquired by Expression 5 and of which difference between the maximum value is within a range of −10, which is a set threshold value, is extracted, only a grid B is extracted. The grid B is output as a referential transmission source position. In this way, the radio wave source position estimation system of the present disclosure is capable of estimating the position of the transmission source. It is assumed that an actual transmission source position in this case is in a vicinity of the grid A as illustrated in FIG. 18.

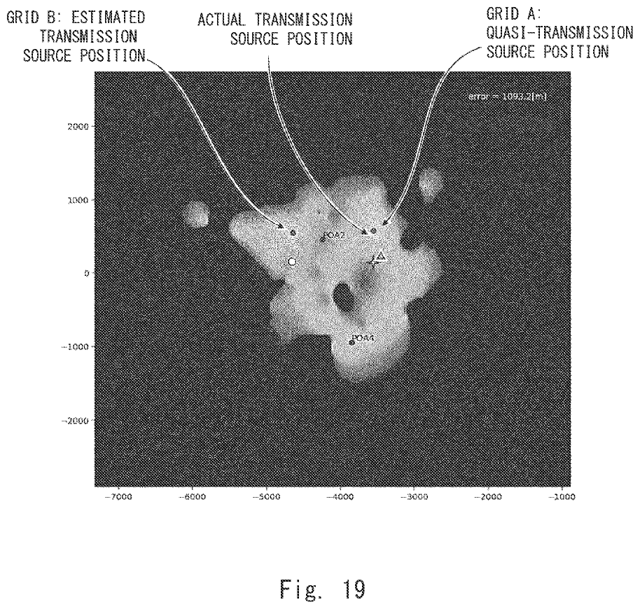

Next, in a time t₂, which is one second after the time t₁, position estimation is performed in a similar way. As illustrated in FIG. 19, the position of the transmission source is almost unchanged and is in the vicinity of the grid A, but received intensities of the sensors 1 to 4 at the time t₂ slightly changed to p1=−88.5 dB, p2=−77.2 dB, p3=−86.3 dB, and p4=−83.3 dB because a surrounding vehicle and the like has moved. A likelihood distribution estimated by using those measured values is illustrated in FIG. 19. Although the likelihood distribution in FIG. 19 is similar to the likelihood distribution in FIG. 18, a likelihood value of each grid changes slightly. First, a grid with the maximum likelihood changes to the grid B, local maximum values of the likelihood are calculated at several points, and among those local maximum values, the grid A is the only grid with a local maximum value having the likelihood L within −10 from the maximum likelihood value. In this case, first, the grid B having the maximum likelihood is output as a transmission source position. Then, when information of the transmission source position in a period of 10 seconds, which is a set time, in the past from the time t₂ to the time t₂ is fetched from the storage unit 64 and compared with the grid having the detected local maximum value, the likelihood becomes the maximum value at the grid A at the time t₁ in the set period and the grid A is estimated as a transmission source position, and therefore the grid A is outputted as a quasi-transmission source position.

In a general method, since only the grid B is output as a transmission source position, the transmission source appears to have moved largely from the time t₁ to the time t₂, but in the present disclosure, the grid A, which is close to the actual transmission source position, is also output as a quasi-transmission source position, and therefore it can be determined that there is a possibility that a transmission source exists in the grid A, and a search for an unknown radio station can be conducted using both the grid A and the grid B as candidates for a transmission source position. It should be noted that applying time-series filter processing such as moving average to an estimation result is not effective because an estimated position is estimated to be in a middle of the grid A and the grid B and a determination having a large error from the actual position is made.

As described above, the present disclosure displays the likelihood distribution in the estimated power, and also displays the quasi-transmission source position by referring to the information of the transmission source position estimated within the set period in the past. It will be described that this method is particularly effective when an expected value of a measured value of a radio wave sensor is set discontinuously in accordance with a building, an object, or a breakpoint in a city as in PTL 1 and PTL 2, by illustrating a case where the method is applied to the method of NPL 2 is applied.

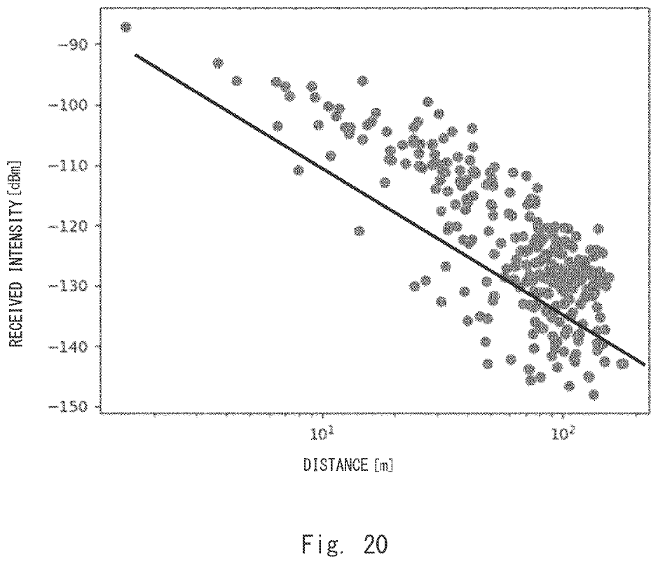

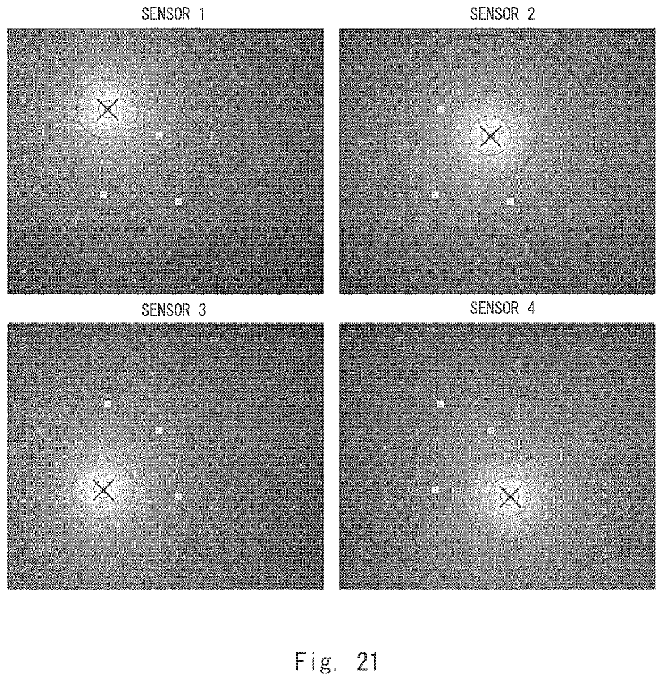

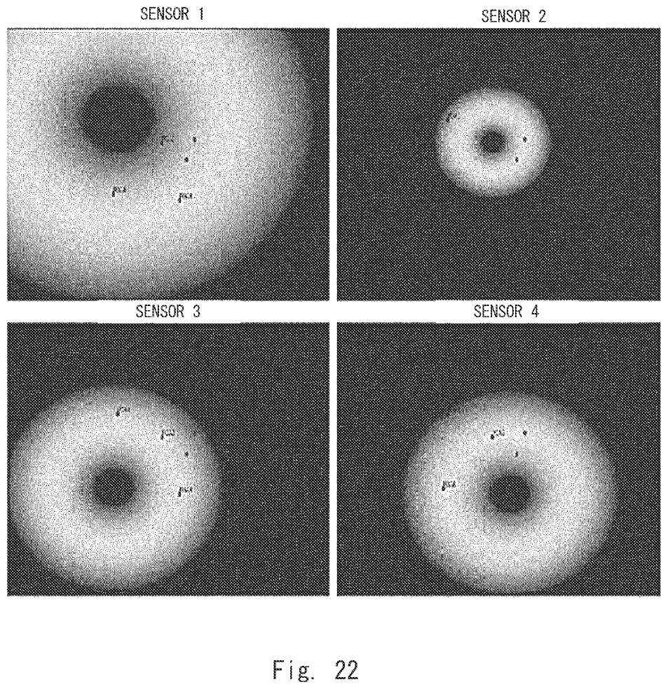

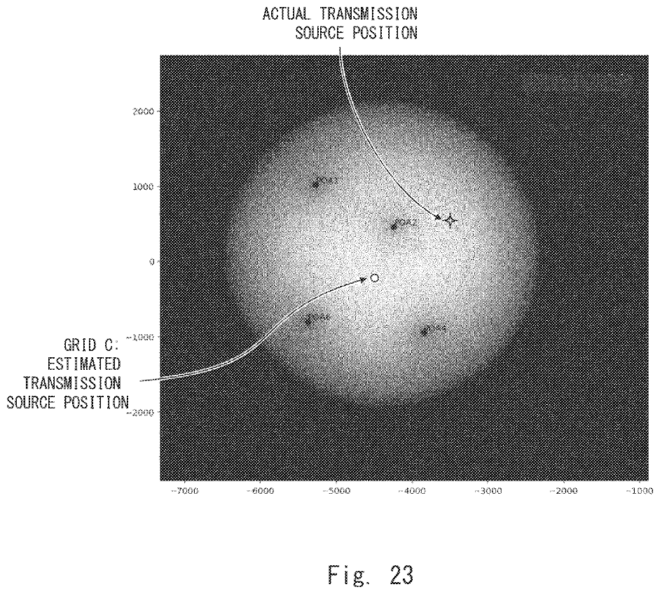

FIG. 20 is a diagram plotting a relationship between the measured value of the received power acquired in the learning phase in FIG. 15 and a distance between the referential source and the sensor. By fitting the relationship to Expression 1 by using a least squares method, the propagation constant (α, β) of Expression 1 is acquired. When the expected value distribution corresponding to FIG. 16 is calculated by using the propagation constant, a distribution which decreases isotropically and continuously around the sensor as illustrated in FIG. 21 is acquired. This is in contrast to the discontinuous distribution in FIG. 16. Then, when the likelihood distribution of each radio wave sensor corresponding to FIG. 17 is calculated by using the measured value at the time t₁ of the present example and Expression 5, a distribution illustrated in FIG. 22 is acquired. Further, a coupled likelihood distribution is as illustrated in FIG. 23, and a grid C having a maximum likelihood is estimated as a transmission source position.

In this method, since a building and a breakpoint in a city that shield a radio wave are not considered, a position distant from an actual transmission source position is estimated as a transmission source position, and a position estimation error is large. Meanwhile, since the distribution of the expected value used for calculating the likelihood is continuous as illustrated in FIG. 21, the coupled likelihood distribution in FIG. 23 to be finally calculated also becomes continuous, and even when the measured value changes, the estimated transmission source position does not largely change discontinuously. In this way, the method of the present disclosure outputs an estimation result that enables analysis of the transmission source position being the estimation target, with respect to a large fluctuation particularly occurs in a case where an expected value of a measured value is set discontinuously in accordance with a building, an object, and a breakpoint in a city.

Although the present invention has been described above with reference to the example embodiment, the present invention is not limited to the above description. Various modifications that can be understood by a parson skilled in the art can be made to the configuration and details of the present invention without departing from the scope of the present invention.

### INDUSTRIAL APPLICABILITY

The present disclosure is applicable to applications such as an illegal radio wave source position estimation system, a self-driving vehicle position estimation system, and a victim position estimation system.

### REFERENCE SIGNS LIST

10 Referential transmission source position measurement device
20 Sensor
30 Analysis server
40 Storage device
50 Position estimation device
51 Preprocessing unit
52 Expected value generation unit
53 Learning data generation unit
54 Spatial distribution synthesis unit
55 Likelihood calculation unit
56 Position estimation unit
57 Display unit
61 Time-series statistical processing unit
62 Power estimation unit
63 Transmission source position estimation unit
64 Storage unit
65 Local maximum value calculation unit
66 Quasi-transmission source position extraction unit

What is claimed is:

1. A radio wave source position estimation system comprising:
at least one memory storing instructions, and
at least one processor configured to execute the instructions to;
acquire an expected value of a measured radio wave feature value when a radio wave is transmitted from a known position, based on a measured radio wave feature value of a radio wave transmitted from a referential transmission source at the known position;
calculate, by synthesizing the expected value at the known position, an expected value of a measured value when a radio wave is transmitted from any position in a target area;
calculate, based on a conformity degree of the expected value and received power measured by a radio wave sensor, a distribution of a conformity degree that a radio wave source exists at each point in a target area;
calculate, based on a calculated conformity degree distribution, a position at which a conformity degree becomes a maximum value or a local maximum value and estimate a position of a transmission source; and
display a spatial distribution of a conformity degree in a target area and an estimated position of a transmission source.

2. The radio wave source position estimation system according to claim 1, wherein the radio wave feature value is received power.

3. The radio wave source position estimation system according to claim 1, wherein the conformity degree is a likelihood based on a probability density function of received intensity, and the distribution of the conformity degree is a likelihood distribution.

4. The radio wave source position estimation system according to claim 1, wherein the at least one processor is further configured to execute the instructions to;
estimate transmission power at which a likelihood becomes maximum, calculates a likelihood distribution at the transmission power, calculates a position at which a likelihood becomes a maximum value or a local maximum value in the likelihood distribution, and
display a likelihood distribution at estimated transmission power.

5. The radio wave source position estimation system according to claim 1, wherein the at least one processor is further configured to execute the instructions to display, as transmission source position candidates, the calculated position of a maximum likelihood value and the calculated position of a local maximum likelihood value.

6. The radio wave source position estimation system according to claim 5, wherein the at least one processor is further configured to execute the instructions to calculate a difference between the calculated local maximum likelihood value and the calculated maximum likelihood value, and output only a local maximum value having the difference that is within a range of a set threshold value.

7. The radio wave source position estimation system according to claim 1, wherein the at least one processor is further configured to execute the instructions to;
output, as a quasi-transmission source position, a local maximum value in a vicinity of a position estimated to be a transmission source position within a specified time period, and output another local maximum value as a referential transmission source position, and
display the transmission source position, the quasi-transmission source position, and the referential transmission source position separately.

8. The radio wave source position estimation system according to claim 1, wherein the at least one processor is further configured to execute the instructions to display a place where a likelihood has reached a maximum value in a specified time period.

9. A radio wave source position estimation method comprising:
acquiring an expected value of a measured radio wave feature value when a radio wave is transmitted from a known position, based on a measured radio wave feature value of a radio wave transmitted from a referential transmission source at the known position;
calculating, by synthesizing the expected value at the known position, an expected value of a measured value when a radio wave is transmitted from any position in a target area;
calculating, based on a conformity degree of the expected value and received power measured by a radio wave sensor, a distribution of a conformity degree that a radio wave source exists at each point in a target area;
calculating, based on a calculated conformity degree distribution, a position at which a conformity degree becomes a maximum value or a local maximum value and estimating a position of a transmission source; and
displaying a spatial distribution of a conformity degree in a target area and an estimated position of a transmission source.

10. The radio wave source position estimation method according to claim 9, wherein the radio wave feature value is received power.

11. The radio wave source position estimation method according to claim 9, wherein the conformity degree is a likelihood based on a probability density function of received intensity, and the distribution of the conformity degree is a likelihood distribution.

12. The radio wave source position estimation method according to claim 9, wherein
the estimating a position of a transmission source comprises estimating transmission power at which a likelihood becomes maximum, calculates a likelihood distribution at the transmission power, calculates a position at which a likelihood becomes a maximum value or a local maximum value in the likelihood distribution, and
the displaying the spatial distribution of the conformity degree comprises displaying a likelihood distribution at estimated transmission power.

13. The radio wave source position estimation method according to claim 9, wherein the displaying the spatial distribution of the conformity degree comprises displaying, as transmission source position candidates, the calculated position of a maximum likelihood value and the calculated position of a local maximum likelihood value.

14. The radio wave source position estimation method according to claim 13, wherein the estimating a position of a transmission source comprises calculating a difference between the calculated local maximum likelihood value and the calculated maximum likelihood value, and outputting only a local maximum value having the difference that is within a range of a set threshold value.

15. The radio wave source position estimation method according to claim 9, wherein
the estimating a position of a transmission source comprises outputting, as a quasi-transmission source position, a local maximum value in a vicinity of a position estimated to be a transmission source position within a specified time period, and outputting another local maximum value as a referential transmission source position, and
the displaying the spatial distribution of the conformity degree comprises displaying the transmission source position, the quasi-transmission source position, and the referential transmission source position separately.

16. The radio wave source position estimation method according to claim 9, wherein the displaying the spatial distribution of the conformity degree comprises displaying a place where a likelihood has reached a maximum value in a specified time period.
